(19) United States
(12) Patent Application Publication
(10) Pub. No.: US 2009/0204392 A1
(43) Pub. Date: Aug. 13, 2009

(54) Communication terminal having speech recognition function, update support device for speech recognition dictionary thereof, and update method

(75) Inventor: Shinya Ishikawa, Tokyo (JP)

Correspondence Address: FOLEY AND LARDNER LLP;SUITE 500, 3000 K STREET NW, WASHINGTON, DC, 20007, US

(73) Assignee: NEC Corporation

(21) Appl. No.: 12/309,246

(22) PCT Filed: Jul. 11, 2007
(86) PCT No.: PCT/JP2007/063796

§ 371 Date: Jan. 12, 2009

(30) Foreign Application Priority Data
Jul. 13, 2006 (JP) 2006-1923011

(51) Int. Cl. G06F 17/21; G10L 15/04

(52) U.S. Cl. 704/10; 704/251; 704/E15.003

(57) ABSTRACT

A simple means for expanding a speech recognition dictionary between communication terminals is provided. A speech recognition dictionary update support device (100) is provided with a speech recognition processing unit (102) which performs speech recognition on content of communication between the communication terminals (200) and also detects words included in a speech recognition dictionary that is a source of dictionary data from a result of the speech recognition, and a permitted word transmission unit (104) which transmits dictionary data corresponding to the detected words to a communication terminal (200) that is a destination of dictionary data. The communication terminals (200) are provided with an addition confirmation unit (202) which confirms with a user whether or not the received dictionary data is to be registered, and performs addition registration to a personal recognition dictionary (201) only in cases in which a registration operation is performed.

### TECHNICAL FIELD

Related application: This application is based upon and claims the benefit of priority of Japanese Patent Application No. 2006-193011, filed on Jul. 13, 2006, the disclosure of which is incorporated herein in its entirety by reference thereto.

The present invention relates to a communication terminal having a built-in speech recognition dictionary for speech recognition, an update support device for the speech recognition dictionary, and an update method.

### BACKGROUND ART

If recorded vocabulary in a speech recognition dictionary (referred to below as simply a “dictionary”) used in speech recognition is increased too much, delays in recognition processing or recognition errors among similar words occur, and conversely, when there are few recorded words in the dictionary, words that are not included in the dictionary cannot be recognized, and recognition accuracy decreases; as a result there are known speech recognition systems which have a personal dictionary, separate from a common dictionary applied to all users.

For example, JP Patent Kokai Publication No. JP-P2005-128076A discloses a speech recognition system which performs speech recognition on speech emitted from a communication terminal, and returns text. The speech recognition system of the same publication discloses a configuration provided with a personal dictionary that registers vocabulary and text which is user-based and is not general purpose, in addition to a common dictionary shared by all communication terminals. Furthermore, in this speech recognition system it is possible to transmit vocabulary and readings thereof from the communication terminals, and to add dictionary data.

Furthermore, JP Patent Kokai Publication No. JP-P2004-072274A discloses, for an extension phone having a plurality of handsets, a configuration provided with user dictionaries (for reading/recognition) that are customizable for each handset, and which applies the user dictionaries of the handsets that are for input and output, to perform speech processing (reading and speech recognition). Furthermore, with respect to the extension phone there is a proposal to provide a function of copying specified dictionary data (a “speech command” in the publication), in order to permit usage of dictionary data of user dictionaries registered for respective handsets in another handset or main telephone.

### [Patent Document 1]

JP Patent Kokai Publication No. JP-P2005-128076A

### [Patent Document 2]

JP Patent Kokai Publication No. JP-P2004-072274A

### DISCLOSURE OF THE INVENTION

### Problems to be Solved by the Invention

The entire disclosures of the abovementioned Patent Documents 1 and 2 are incorporated herein by reference thereto. The following analysis is given by the present invention.

As described in each of the abovementioned publications, in order to obtain a preferable recognition result in speech recognition, it is desirable to provide speech recognition optimized for each speaker. However, in actuality there is no means of easily increasing recorded data in the speech recognition dictionary. For example, Patent Document 1 discloses an example in which each individual registers new dictionary data (refer to FIG. 2 and FIG. 4 of Patent Document 1), but troublesome operations of inputting readings corresponding to vocabulary one by one are necessary.

According to a method described in Patent Document 2, it is possible to give usage permission for a user dictionary of a certain handset to another telephone, but there is a problem in that another user dictionary would be forcibly rewritten due to this permission. This type of method is allowable because of the fact that the extension phone is one for which users are limited, and it is not acceptable among communication terminals used by unspecified users.

Furthermore, in the method described in Patent Document 2, effort is required to specify dictionary data having usage permission, and there is another problem in that the method is not directed towards communication terminals having a dictionary including many words and few commands.

The present invention has been made in light of the above described situation, and has as an object the provision of a system and a communication terminal in which it is possible to simply select dictionary data and to provide it to another communication terminal, and in addition dictionaries are not forcibly rewritten.

### Problems to be Solved by the Invention

According to a first aspect of the present invention there is provided a speech recognition dictionary update support device that is customizable for each user, the device being provided with a speech recognition processing unit which uses a speech recognition dictionary of a communication terminal that is a source of dictionary data, to perform speech recognition on speech emitted from the communication terminal that is the source of the dictionary data, and also detects words included in the speech recognition dictionary of the communication terminal that is the source of the dictionary data, from a result of the speech recognition; and a dictionary data registration unit which, on obtaining consent from a communication terminal that is a destination of dictionary data, registers dictionary data corresponding to the detected words in a speech recognition dictionary of the destination communication terminal; wherein, dictionary data can be provided to an arbitrary communication terminal by speech input of arbitrary words.

According to a second aspect of the present invention there is provided a speech recognition dictionary update support device held by a communication terminal having a speech recognition function, the device being provided with a speech recognition processing unit which uses a speech recognition dictionary of a communication terminal that is a source of dictionary data, to perform speech recognition on speech emitted from the communication terminal that is the source of the dictionary data, and also detects words included in the speech recognition dictionary of the communication terminal that is the source of the dictionary data, from a result of the speech recognition; and a dictionary data transmission unit which transmits dictionary data corresponding to the detected words to a communication terminal that is a destination of dictionary data; wherein, dictionary data can be transmitted to an arbitrary communication terminal by speech input of arbitrary words; and there is provided a communication terminal in which dictionary data can be transmitted and received via the update support device.

According to a third aspect of the present invention there is provided a communication terminal having a function of performing speech recognition on input speech, and a function of transmitting dictionary data used in the speech recognition, the communication terminal being provided with a speech recognition processing unit which uses its own speech recognition dictionary to perform speech recognition on input speech, and also detects words included in its own speech recognition dictionary, from a result of the speech recognition; a dictionary data transmission unit which transmits dictionary data corresponding to the detected words, to another communication terminal; and an addition confirmation unit which, when the dictionary data has been received, on confirming whether or not the dictionary data is to be added to its own speech recognition dictionary, performs registration; wherein dictionary data corresponding to arbitrary words of input speech is transmitted to and received from an arbitrary communication terminal.

According to a fourth aspect of the present invention, there is provided a method of updating a speech recognition dictionary provided for each communication terminal having a speech recognition function (that is, customizable for each user), the method including a step in which a speech recognition dictionary update support device uses a speech recognition dictionary of a communication terminal that is a source of dictionary data to perform speech recognition on speech emitted from the communication terminal that is the source of the dictionary data, and also detects words included in the speech recognition dictionary of the communication terminal that is the source of the dictionary data, from a result of the speech recognition; a step in which the speech recognition dictionary update support device confirms whether or not the dictionary data detected in the speech recognition dictionary of the communication terminal should be added to the speech recognition dictionary of a communication terminal that is a destination of dictionary data; and a step in which the speech recognition dictionary update support device registers dictionary data corresponding to the detected words, in the speech recognition dictionary of the communication terminal that is the destination of the dictionary data, in accordance with a result of the confirmation.

According to a fifth aspect of the present invention there is provided a method of updating a speech recognition dictionary held in a communication terminal having a speech recognition function, the method including a step in which a speech recognition dictionary update support device uses a speech recognition dictionary of a communication terminal that is a source of dictionary data, to perform speech recognition on speech emitted from the communication terminal that is the source of the dictionary data, and also detects words included in the speech recognition dictionary that is the source of the dictionary data, from a result of the speech recognition; a step in which the speech recognition dictionary update support device transmits dictionary data corresponding to the detected words to a communication terminal that is a destination of dictionary data; and a step in which the communication terminal that has received the dictionary data adds the dictionary data to its own speech recognition dictionary, according to a user operation.

According to a sixth aspect of the present invention there is provided a method of updating a speech recognition dictionary held in a communication terminal having a speech recognition function, the method including a step in which one communication terminal uses its own speech recognition dictionary to perform speech recognition on input speech, and also detects words included in its own speech recognition dictionary from a result of the speech recognition; a step in which the one communication terminal transmits dictionary data corresponding to the detected words to another communication terminal; and a step in which the other communication terminal adds the dictionary data to its own speech recognition dictionary, according to a user operation.

### MERITORIOUS EFFECTS OF THE INVENTION

According to the present invention it is possible to select dictionary data of a communication terminal and distribute the dictionary data to another communication terminal, by only uttering a word that is desired to be passed to the other communication terminal. Furthermore, according to the present invention, since only dictionary data is transmitted, a speech recognition dictionary of a communication terminal on a receiving side is not forcibly rewritten.

### BRIEF DESCRIPTION OF THE DRAWINGS

FIG. 1 is a drawing showing a system configuration of a first exemplary embodiment of the present invention.

FIG. 2 is a flowchart showing operations performed on a speech recognition dictionary update support device side in the first exemplary embodiment of the present invention.

FIG. 3 is a flowchart showing operations performed on a mobile telephone unit (communication terminal) side in the first exemplary embodiment of the present invention.

FIG. 4 is a reference drawing for specifically describing an effect of the present invention.

FIG. 5 is a drawing showing a system configuration of a second exemplary embodiment of the present invention.

FIG. 6 is a drawing showing a configuration of a mobile telephone unit (communication terminal) of a third exemplary embodiment of the present invention.

### PREFERRED MODE FOR CARRYING OUT THE INVENTION

Next, a detailed description is given of preferred modes for realizing the present invention, making reference to the drawings.

### First Exemplary Embodiment

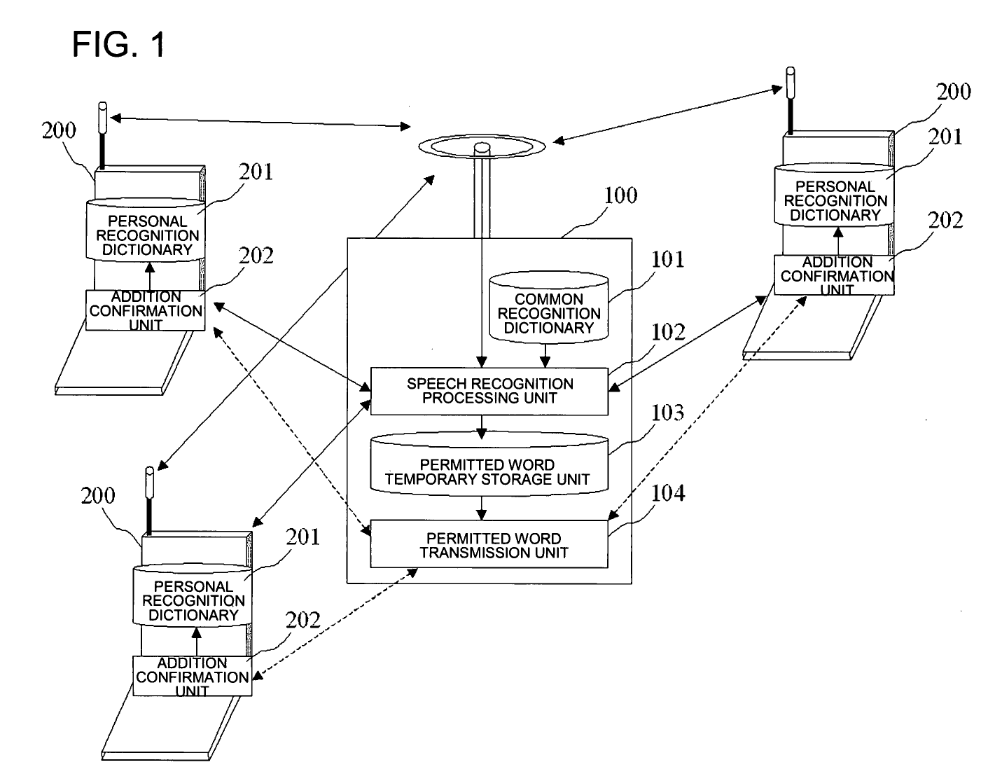

FIG. 1 is a drawing showing a system configuration of a first exemplary embodiment of the present invention. FIG. 1 shows a plurality of mobile telephone units (communication terminals) 200, and a speech recognition dictionary update support device 100 disposed in a telephone exchange that relays communication between the speech recognition dictionary update support devices 200.

The speech recognition dictionary update support device 100 is provided with a common recognition dictionary (a common speech recognition dictionary) 101 used in recognition processing of communicated speech of the mobile telephone units 200; a speech recognition processing unit 102 which performs the recognition processing of communicated speech; a permitted word temporary storage unit 103 which temporarily stores words in a personal recognition dictionary (user dictionary) 201 of each of the mobile telephone units 200, detected by being uttered during communication and for which permission to distribute to others has been given; and a permitted word transmission unit (dictionary data transmission unit) 104 which transmits words stored in the permitted word temporary storage unit 103 to the mobile telephone units 200 when communication is completed.

The speech recognition processing unit 102 receives the personal recognition dictionaries 201 from the mobile telephone units 200 performing communication at the same time as communication is started between the mobile telephone units 200. The speech recognition processing unit 102 refers to the personal recognition dictionaries 201 received from each of the mobile telephone units 200 and the common recognition dictionary 101, and performs recognition processing of communicated speech between each of the mobile telephone units 200.

As a result of the recognition processing of the communicated speech, when the speech recognition processing unit 102 detects a word registered in a personal recognition dictionary 201 received from any of the mobile telephone units 200, this word is recorded in the permitted word temporary storage unit 103.

When communication is completed at any of the mobile telephone units 200, the permitted word transmission unit (dictionary data transmission unit) 104 transmits words (dictionary data) stored in the permitted word temporary storage unit 103 at that point in time to the mobile telephone unit 200 at which the communication has been completed.

A mobile telephone unit 200 is configured by being provided with the personal recognition dictionary 201 that is customizable, a control unit (omitted from the drawings) that transmits the personal recognition dictionary 201 when a communication request is performed in a prescribed dictionary data provision mode, to the speech recognition dictionary update support device 100, and an addition confirmation unit 202 which, on confirming with a user whether or not to add a word passed from the permitted word transmission unit 104 of the speech recognition dictionary update support device 100 to the personal recognition dictionary 201, performs registration to the personal recognition dictionary 201.

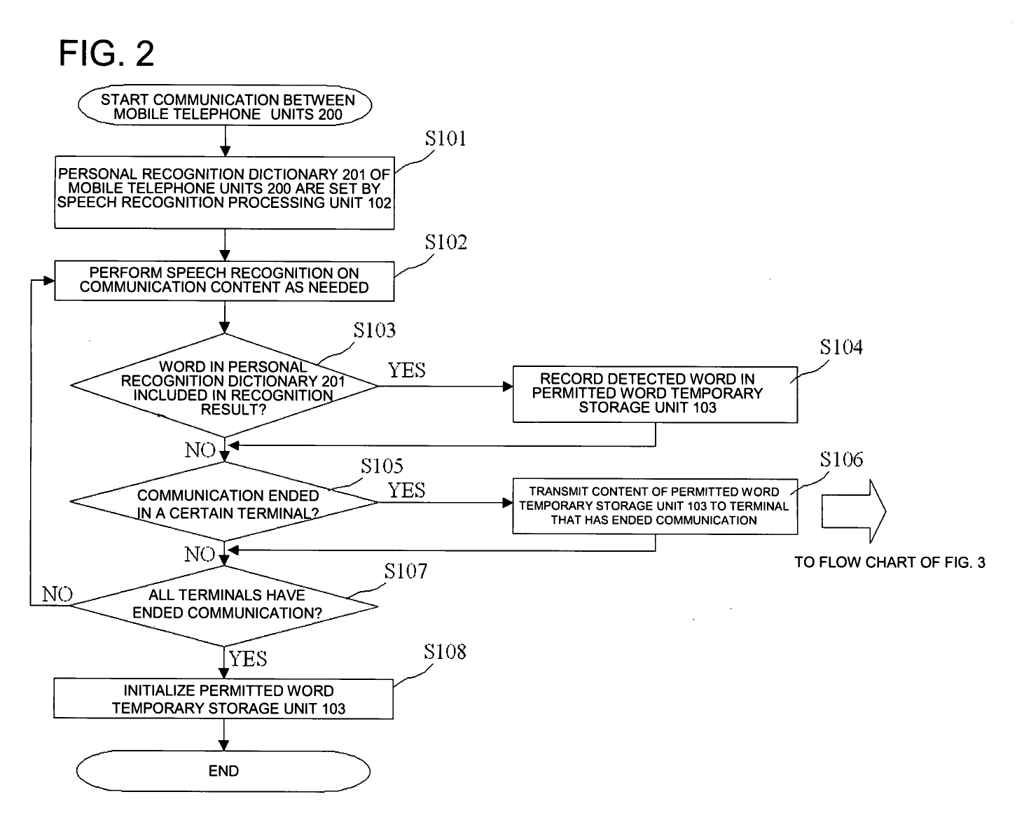

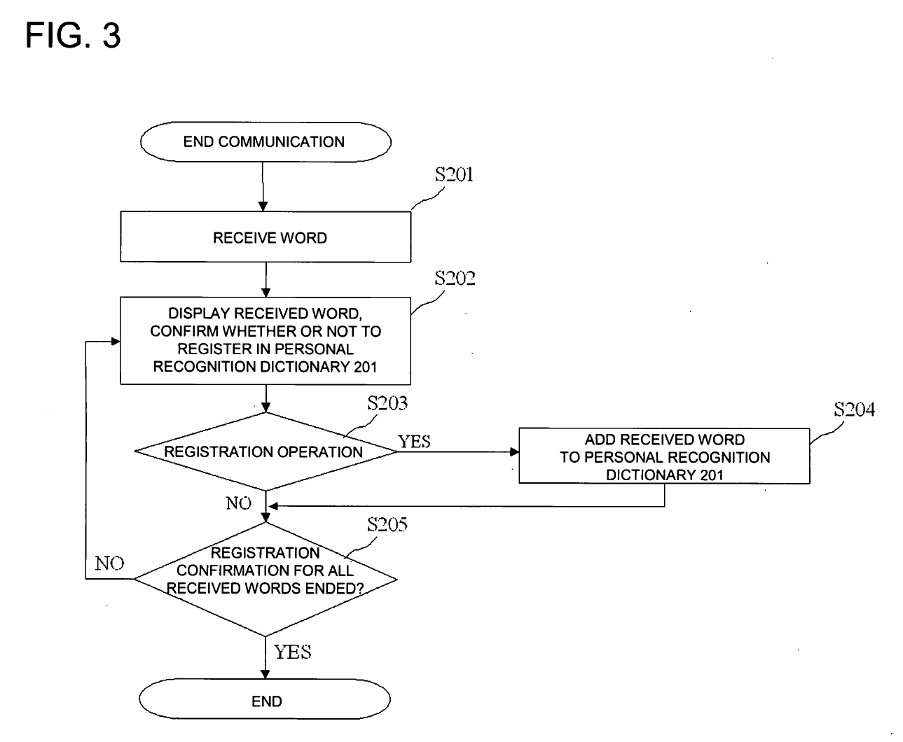

Next, a detailed description of operation of the present exemplary embodiment is given, making reference to the drawings. FIG. 2 is a flowchart showing operation performed on the speech recognition dictionary update support device 100 side when communication is started. FIG. 3 is a flowchart showing operations performed on the mobile telephone unit (communication terminal) 200 side when communication is completed. Below, the operation of the present exemplary embodiment is described in order of FIG. 2 and FIG. 3.

As shown in FIG. 2, at the same time as communication starts, the personal recognition dictionary 201 is transmitted from a mobile telephone unit 200 to the speech recognition processing unit 102 of the speech recognition dictionary update support device 100 (Step S101). For example, in cases in which communication among three parties is performed between three mobile telephone units 200 as in FIG. 1, three personal recognition dictionaries 201 are set by the speech recognition processing unit 102.

Next, the speech recognition processing unit 102 uses content of the personal recognition dictionaries 201 received from each of the mobile telephone units 200, and the common recognition dictionary 101 to perform speech recognition as needed in response to utterances from the mobile telephone units 200 (Step S102).

Here, the speech recognition processing unit 102 confirms a recognition result as needed, during this speech recognition processing, and when it is confirmed that a word included in the personal recognition dictionary 201 of any of the mobile telephone units 200 has been recognized as speech (YES in Step S103), this word is recorded in the permitted word temporary storage unit 103 (Step S104).

When one of the mobile telephone units 200 taking part in communication ends the communication (YES in Step S105), the permitted word transmission unit 104 transmits all words recorded in the permitted word temporary storage unit 103 at that point in time, to the mobile telephone unit 200 that has ended the communication (Step S106).

When all of the mobile telephone units 200 end communication (YES in Step S107), after performing the operation of transmitting the words (dictionary data) of Step S106 in FIG. 2, content of the permitted word temporary storage unit 103 is deleted (Step S108).

The speech recognition dictionary update support device 100 performs repetition of the above described processing until communication of all of the mobile telephone units 200 is ended, detects words registered in the personal recognition dictionary 201 of each of the mobile telephone units 200, and repeats an operation of recording to the permitted word temporary storage unit 103 (NO in Step S107).

Meanwhile, when communication in the mobile telephone units 200 is ended, as shown in FIG. 3, the mobile telephone units 200 receive words transmitted from the speech recognition dictionary update support device 100 (Step S201; Step S106 in FIG. 2).

The mobile telephone units 200 that have received the words activate the addition confirmation unit 202, display the received words on a display thereof, individually or as a plurality thereof collected together, and enquire of a user whether to not to add to the personal recognition dictionary 201 (Step S202).

Here, in cases in which a prescribed registration operation is performed by the user (YES in Step S203), the addition confirmation unit 202 performs an adding registration of words on which the registration operation is performed, to the personal recognition dictionary 201 (Step S204).

With the words received from the speech recognition dictionary update support device 100, the addition confirmation unit 202 repeats the operations of the abovementioned Steps S202 to S204 as to whether or not to perform registration, until there are no unconfirmed words (Step S205).

As described above, according to the speech recognition dictionary update support device 100 related to the present exemplary embodiment, it is possible to transmit a word included in the personal recognition dictionary 201 contained in each person's mobile telephone unit 200, to a mobile telephone unit 200 of another communication party, by only mentioning the word in the communication.

In general, an arbitrary word being used in the communication is equivalent to an example of the word or an explanation of its meaning being given, at the same time, even if not directly performed. Therefore, according to the speech recognition dictionary update support device 100 related to the present exemplary embodiment, information as to whether or not a word (dictionary data) is useful to a side receiving the word (dictionary data), is transmitted naturally while performing normal language communication.

Furthermore, according to the mobile telephone units (communication terminals) 200 related to the present exemplary embodiment, not only information relating to utility of the abovementioned word (dictionary data) is obtained, it is also possible to perform registration in the personal recognition dictionary 201 after judging whether or not the word (dictionary data) is necessary.

Furthermore, in general if the number of recorded words in the speech recognition dictionary is increased too much, a disadvantage occurs in that words with which the user is unfamiliar appear as mistaken recognition results, and it is important to carefully select the recorded words; however, as described above, according to the mobile telephone units (communication terminals) 200 related to the present exemplary embodiment, since words (dictionary data) of no use are not registered, it is possible to inhibit deterioration of recognition accuracy.

In the abovementioned exemplary embodiment, a description has been given in which all detected words are transmitted to the mobile telephone unit (communication terminal) 200 that has ended communication; however, a duplicated check may also be performed as to whether or not a word is registered already in the personal recognition dictionary 201 of the mobile telephone unit (communication terminal) 200, on the speech recognition dictionary update support device 100 side. Or, it is also possible to ask the user whether or not to perform the registration after confirming whether a word is already registered in the personal recognition dictionary 201, by the addition confirmation unit 202 of the mobile telephone unit (communication terminal) 200.

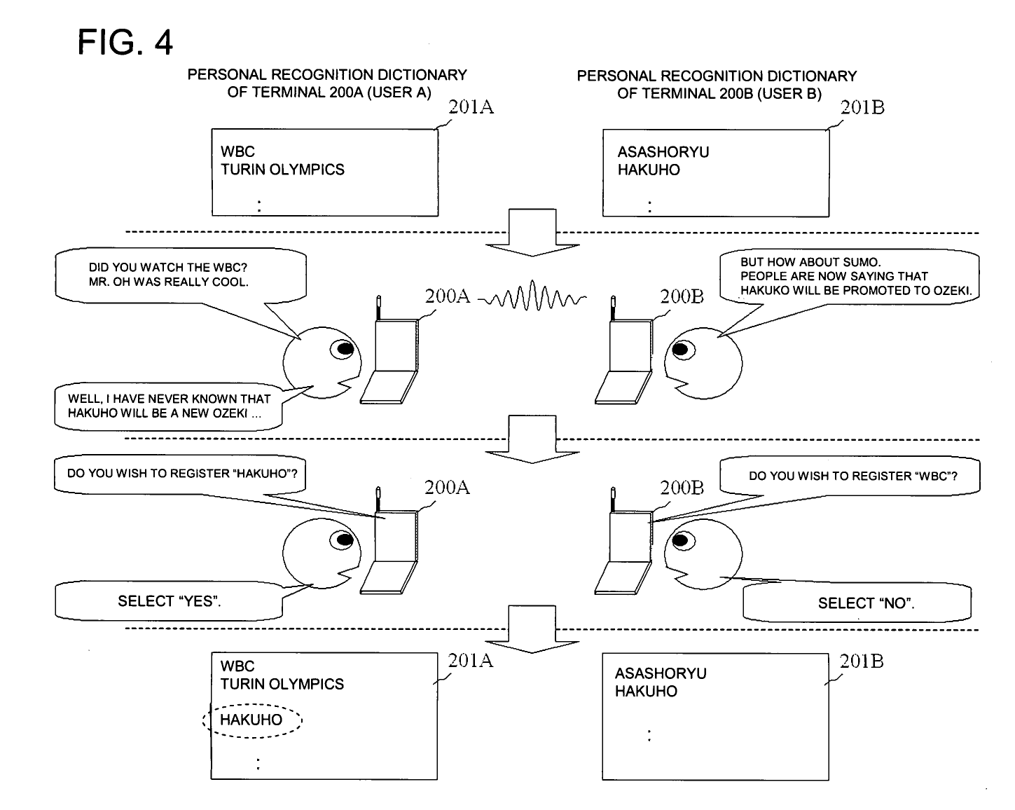

Next, a specific operational example of the present invention is illustrated to describe more simply an effect of the present invention. FIG. 4 shows an example in which communication is performed between two parties (user A and user B) using two mobile telephone units (communication terminals), and word (dictionary data) addition is performed.

In a pre-communication state shown in an uppermost stage of FIG. 4, the mobile telephone unit 200A and the mobile telephone unit 200B each hold different words in the personal recognition dictionaries 201A and 201B. The user A is interested in international sports events, and keywords such as “WBC” (World Baseball Classic), “Turin Olympics”, and the like, are registered in the personal recognition dictionary 201A of this mobile telephone unit 200A. On the other hand, the user B is interested in Sumo, and wrestlers' names such as “Asashoryu” and “Hakuho” are registered in the personal recognition dictionary 201B of this mobile telephone unit 200B.

By referring to content in which each of them are interested during communication via the speech recognition dictionary update support device 100, as shown in a second stage from the top of FIG. 4, a confirmation message is displayed as to whether or not to register words that each party has mentioned, in the personal recognition dictionaries 201A and 201B, as shown in a subsequent stage when the communication is ended.

For example, the user A has become interested in the wrestler “Hakuho” due to conversation with the user B, and considering that there is a possibility that he himself will use the word as a topic in the future, he selects to add it to the personal recognition dictionary 201A. In this way, in cases in which speech including “Hakuho” is inputted thereafter and speech recognition is performed by the mobile telephone unit 200A, the personal recognition dictionary 201A that includes the keyword “Hakuho” is referred to, and it is possible to perform precise speech recognition.

On the other hand, since the user B is not interested in keywords occurring in conversation with the user A, the user B considers that there is no possibility that he himself will use the words as topics in the future, and he rejects making an addition to the personal recognition dictionary 201B. In this way, in the mobile telephone unit 200B, in cases in which a word that is easily mistakenly recognized as “WBC” is inputted as speech thereafter, since the keyword “WBC” is not registered in the personal recognition dictionary 201B, it is possible to inhibit the mistaken recognition of “WBC”.

As shown in the above example, according to the present invention, it is possible to distinguish among words (dictionary data) added to the speech recognition dictionary through natural conversation, and it is possible to maintain the speech recognition dictionary of each user in a state in which only words matching individual preferences are recorded.

### Second Exemplary Embodiment

Next, a description will be given concerning a second exemplary embodiment of the present invention in which a modification is added to the above described first exemplary embodiment.

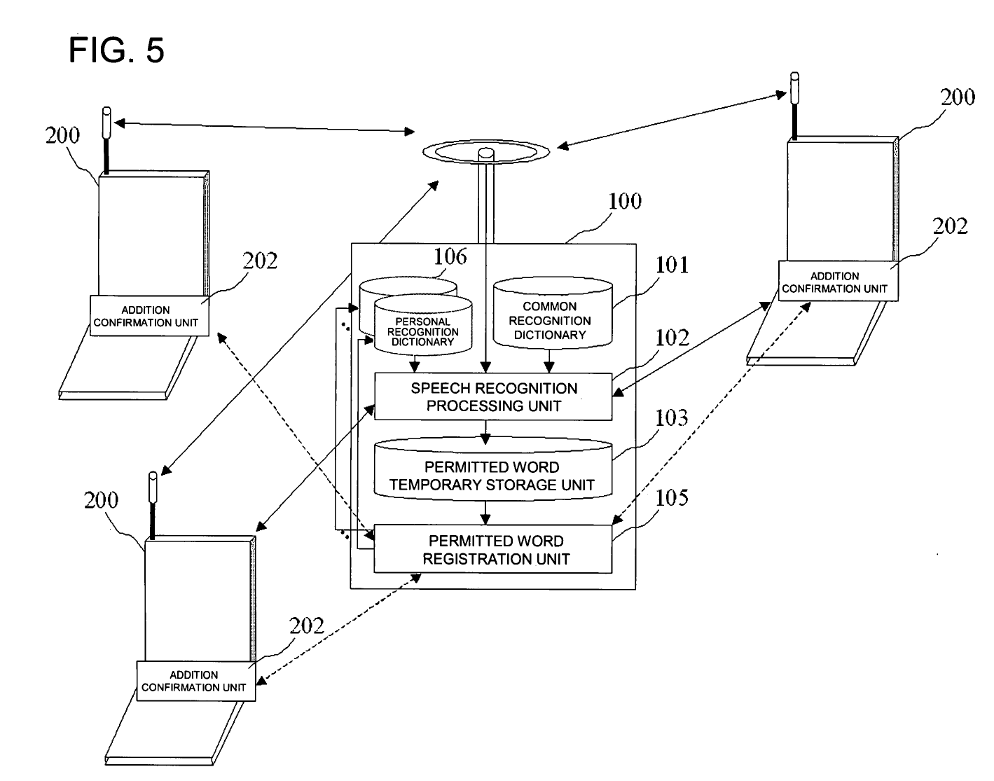

FIG. 5 is a drawing showing a system configuration of the second exemplary embodiment of the present invention. Referring to FIG. 5, there are two points of difference from the first exemplary embodiment: the point that a permitted word registration unit (dictionary data registration unit) 105 is provided instead of a permitted word transmission unit 104, and the point that a personal recognition dictionary 106 (201 in FIG. 1) is disposed on a speech recognition dictionary update support device 100 side.

Operation of the present exemplary embodiment is substantially the same as the abovementioned first exemplary embodiment, and a speech recognition processing unit 102 makes reference to a common recognition dictionary 101 and a personal recognition dictionary 106, to perform speech recognition (refer to Step S102 in FIG. 2). However, in the present exemplary embodiment, since the personal recognition dictionary 106 is on the speech recognition dictionary update support device 100 side, transmission of the personal recognition dictionary as in the first exemplary embodiment is unnecessary.

The speech recognition processing unit 102 confirms a recognition result as needed, during this speech recognition processing, and when it is confirmed that a word included in the personal recognition dictionary 106 of any mobile telephone unit 200 has been recognized as speech (refer to YES in Step S103 of FIG. 2), this word is recorded in a permitted word temporary storage unit 103 (refer to Step S104 in FIG. 2).

When one of the mobile telephone units 200 taking part in communication ends the communication (YES in Step S105 of FIG. 2), the permitted word registration unit (dictionary data registration unit) 105 confirms whether or not a word recorded in the permitted word temporary storage unit 103 at that point in time is to be registered in the personal recognition dictionary, with the mobile telephone unit 200 that has ended the communication.

Here, if a positive response is obtained, the permitted word registration unit (dictionary data registration unit) 105 registers the word (dictionary data) for which the confirmation was obtained, in the personal recognition dictionary 106 of the mobile telephone unit 200. Conversely, if there is a negative response, the permitted word registration unit (dictionary data registration unit) 105 does not perform registration of the word (dictionary data).

When all the mobile telephone units 200 end communication (refer to YES of Step S107 in FIG. 2), the point that content of the permitted word temporary storage unit 103 is deleted after confirmation of the dictionary data and performing the registration operation is similar to the abovementioned first exemplary embodiment.

According to a configuration of the present exemplary embodiment, similar to the first exemplary embodiment, it is possible to simply realize plentiful recorded data in the speech recognition dictionary of each user.

### Third Exemplary Embodiment

Next, a description will be given concerning a third exemplary embodiment of the present invention which realizes provision and exchange of words (dictionary data) as described above with only mobile telephone units 200, without using a speech recognition dictionary update support device 100 as described above.

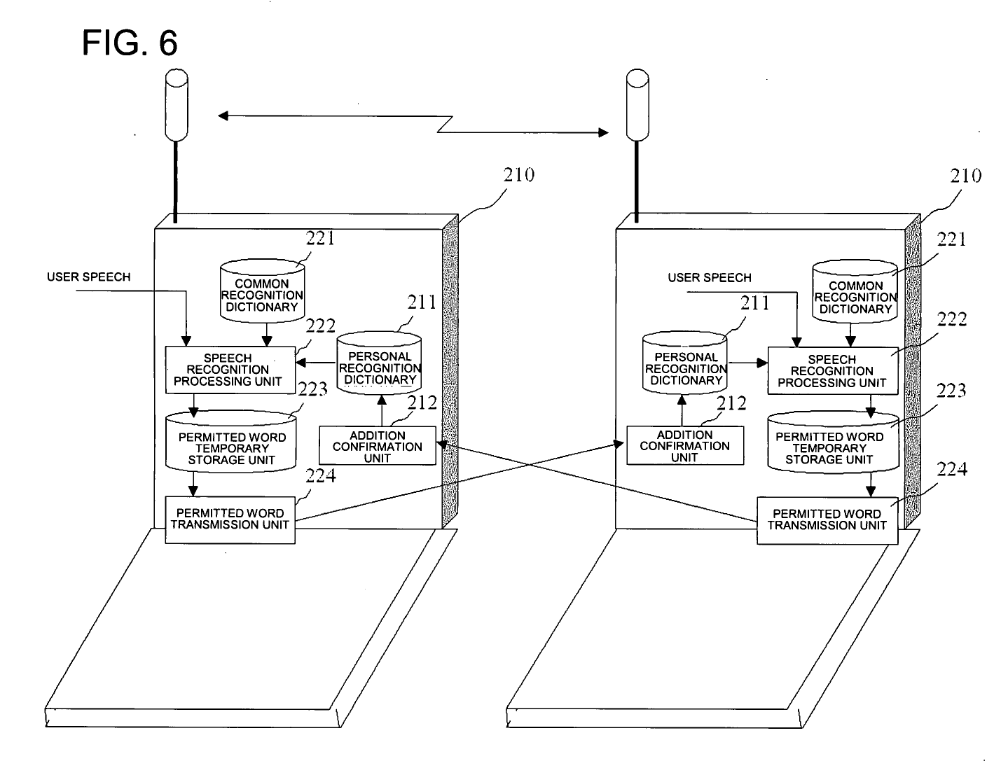

FIG. 6 is a drawing showing a configuration of a mobile telephone unit of the third exemplary embodiment of the present invention. FIG. 6 shows mobile telephone units (communication terminals) 210 provided with, in addition to a personal recognition dictionary 211 and an addition confirmation unit 212, as described in the abovementioned first exemplary embodiment, a common recognition dictionary (common speech recognition dictionary) 221, a speech recognition processing unit 222, a permitted word temporary storage unit 223, and a permitted word transmission unit (dictionary data transmission unit) 224.

The abovementioned common recognition dictionary (common speech recognition dictionary) 221, the speech recognition processing unit 222, the permitted word temporary storage unit 223, and the permitted word transmission unit (dictionary data transmission unit) 224 are respectively equivalent to the common recognition dictionary (common speech recognition dictionary) 101, the speech recognition processing unit 102, the permitted word temporary storage unit 103, and the permitted word transmission unit 104, of the speech recognition dictionary update support device 100 of the abovementioned first exemplary embodiment.

The common recognition dictionary 221 is a dictionary written when a mobile telephone is shipped, and if device types of the mobile telephone units 210 are basically the same, content thereof is the same.

The speech recognition processing unit 222 uses the common recognition dictionary 221 and the personal recognition dictionary 211 when communication is taking place in a state in which a prescribed dictionary data provision mode is selected, and recognizes a user's speech inputted from a receiver or the like of a mobile telephone unit 210. Furthermore, as a result of the speech recognition, when the speech recognition processing unit 222 detects a word that is registered in the personal recognition dictionary 211 of its own device, it records this word in the permitted word temporary storage unit 223.

Furthermore, the present exemplary embodiment is configured so that, since transmission is not via the speech recognition dictionary update support device 100, the permitted word transmission unit 224 provided in each of the mobile telephone units 210 transmits words (dictionary data) stored in the permitted word temporary storage unit 223 to an appropriately designated mobile telephone unit 210. With regard to a transmission method of the words (dictionary data), it is sufficient to specify a mobile telephone unit of another party, and transmission may be performed via a mobile telephone unit network, or transmission may be done using Near Field Communication or infrared communication.

The addition confirmation unit 212, similar to the abovementioned first exemplary embodiment, performs confirmation as to whether or not to register a word (dictionary data) transmitted from the permitted word transmission unit 224 in the personal recognition dictionary 211, and performs an addition registration to the personal recognition dictionary 211 only in necessary cases.

With regard to operation in the present exemplary embodiment also, similar to the abovementioned first exemplary embodiment, it is possible to transmit recorded words of the personal recognition dictionary 211 included in uttered content, to a mobile telephone unit 210.

A description has been given of a preferred mode for realizing the present invention, but it is clearly possible to add various types of modification within a scope that does not depart from the spirit of the present invention, in which dictionary data to be transmitted according to input speech is specified and is transmitted to another communication terminal. For example, in each of the abovementioned exemplary embodiments, examples were described of configurations respectively having a common recognition dictionary and a personal recognition dictionary, but giving consideration to principles of the present invention, application is possible not only to this configuration, but also to communication equipment in general, that has a speech recognition dictionary to which dictionary data can be added.

Furthermore, for example, in each of the abovementioned exemplary embodiments, descriptions have been given in which only words used in speech recognition are recorded in the personal recognition dictionary and the common recognition dictionary, but a dictionary in which used examples (corpus) of text and phrases including recorded words may also be preferably used. In this way, it is possible to improve recognition rate in speech recognition. Furthermore, each of the dictionaries can also include statistical information such as single appearance frequency of each recorded word, single appearance probability (unigram probability), or number of appearances of word sequences including the word, and appearance probability (N-gram probability).

In such cases, it is possible to transmit and receive usage examples of these also, as dictionary data, and to register them in a speech recognition dictionary of a communication terminal of another party. For example, when a new word is introduced by a communication party, and an operation is performed to register this word in the personal recognition dictionary, it is possible to also receive usage example text (at least one sentence) including that word or example phrase, and it is possible to realize more highly accurate speech recognition. In the same way, if the abovementioned statistical information with respect to this word is exchanged and reflected in a statistical language model, it is possible to realize even more highly accurate speech recognition.

In each of the abovementioned exemplary embodiments descriptions have been given citing examples that use mobile telephone units as communication terminals, but the present invention can also be applied in a similar way to other internal telephones and domestic extension phones.

In addition, further modifications and adjustments are possible within the bounds of the entire disclosure (including the scope of the claims) of the present invention, based on fundamental technological concepts thereof. Furthermore, a wide variety of combinations and selections of various disclosed elements are possible within the scope of the claims of the present invention.

Moreover, further issues, objects and development modes of the present invention will be clear from the entire disclosure including the scope of the claims of the present invention.

1. A speech recognition dictionary update support device that is customizable for each user, the device comprising:
a speech recognition processing unit which uses a speech recognition dictionary of a communication terminal that is a source of dictionary data, to perform speech recognition on speech emitted from said communication terminal that is the source of the dictionary data, and also detects a word included in said speech recognition dictionary of said communication terminal that is the source of the dictionary data, from a result of said speech recognition; and
a dictionary data registration unit which, on obtaining consent from a communication terminal that is a destination of dictionary data, registers dictionary data corresponding to said detected word in a speech recognition dictionary of said destination communication terminal; wherein,
dictionary data can be provided to an arbitrary communication terminal by speech input of an arbitrary word.

2. A speech recognition dictionary update support device held by a communication terminal having a speech recognition function, the device comprising:
a speech recognition processing unit which uses a speech recognition dictionary of a communication terminal that is a source of dictionary data, to perform speech recognition on speech emitted from said communication terminal that is the source of the dictionary data, and also detects a word included in said speech recognition dictionary of said communication terminal that is the source of the dictionary data, from a result of said speech recognition; and
a dictionary data transmission unit which transmits dictionary data corresponding to said detected words to a communication terminal that is a destination of dictionary data; wherein,
dictionary data can be provided to an arbitrary communication terminal by speech input of an arbitrary word.

3. The speech recognition dictionary update support device according to claim 1, wherein
said speech recognition processing unit performs speech recognition on communication content between a communication terminal that is a destination and a communication terminal that is a source of dictionary data, and detects a word included in a speech recognition dictionary of said communication terminal that is the source of the dictionary data.

4. The speech recognition dictionary update support device according to claim 1, wherein
separately from said dictionary data, said speech recognition processing unit transmits a speech recognition result to said communication terminal that is the destination of the dictionary data.

5. The speech recognition dictionary update support device according to claim 1, wherein
at least one sentence including a word or a phrase is held in said speech recognition dictionary;
said speech recognition processing unit performs speech recognition by referring to said sentence; and
said dictionary data registration unit registers dictionary data including said sentence.

6. The speech recognition dictionary update support device according to claim 1, wherein
at least one sentence including a word or a phrase is held in said speech recognition dictionary;
said speech recognition processing unit performs speech recognition by referring also to said sentence; and
said dictionary data transmission unit transmits dictionary data including said sentence.

7. The speech recognition dictionary update support device according to claim 1, being built into a network side device that relays communication between a plurality of communication terminals, wherein
said speech recognition processing unit uses speech recognition dictionaries received from said plurality of communication terminals to convert content of communication between said plurality of communication terminals into text, to be transmitted to each of said communication terminals, and also detects a word included in each of said speech recognition dictionaries, and
said dictionary data registration unit registers dictionary data corresponding to said detected word, in a speech recognition dictionary of a terminal that has ended said communication.

8. The speech recognition dictionary update support device according to claim 2, being built into a network side device that relays communication between a plurality of communication terminals, wherein
said speech recognition processing unit uses speech recognition dictionaries received from said plurality of communication terminals to convert content of communication between said plurality of communication terminals into text, to be transmitted to each of said communication terminals, and also detects a word included in each of said speech recognition dictionaries, and
said dictionary data transmission unit transmits dictionary data corresponding to said detected word, to a terminal that has ended said communication.

9. A communication terminal that enables transmission of its own speech recognition dictionary to the speech recognition dictionary update support device of claim 2, and also transmission of dictionary data to an arbitrary communication terminal, by speech input of an arbitrary word.

10. A communication terminal comprising: an addition confirmation unit which, when said dictionary data has been received from the speech recognition dictionary update support device of claim 2, confirms whether or not to add to its own speech recognition dictionary before registration.

11. A communication terminal having a function of performing speech recognition on input speech and a function of transmitting dictionary data used in said speech recognition, the communication terminal comprising:
a speech recognition processing unit which uses its own speech recognition dictionary to perform speech recognition on input speech, and also detects a word included in its own speech recognition dictionary, from a result of said speech recognition;
a dictionary data transmission unit which transmits dictionary data corresponding to said detected word, to an other communication terminal; and
an addition confirmation unit which, when said dictionary data has been received, on confirming whether or not to add to its own speech recognition dictionary, performs registration; wherein
dictionary data corresponding to an arbitrary word of inputted speech can be transmitted to and received from an arbitrary communication terminal.

12. The communication terminal according to claim 11, wherein
separately from said dictionary data, said speech recognition processing unit transmits a speech recognition result to said other communication terminal.

13. The communication terminal according to claim 11, wherein
at least one sentence including a word or a phrase is also held in said speech recognition dictionary;
said speech recognition processing unit performs speech recognition by referring to said sentence; and
said dictionary data transmission unit transmits dictionary data including said sentence.

14. A method of updating a speech recognition dictionary that is customizable for each user, the method comprising:
a step in which a speech recognition dictionary update support device uses a speech recognition dictionary of a communication terminal that is a source of dictionary data, to perform speech recognition on speech emitted from said communication terminal that is the source of the dictionary data, and also detects a word included in said speech recognition dictionary that is the source of said dictionary data, from a result of said speech recognition;
a step in which said speech recognition dictionary update support device confirms whether or not said dictionary data detected in the speech recognition dictionary of said communication terminal should be added to a communication terminal that is a destination of dictionary data; and
a step in which said speech recognition dictionary update support device registers dictionary data corresponding to said detected word, in said speech recognition dictionary of said destination communication terminal, in accordance with a result of said confirmation

15. A method of updating a speech recognition dictionary held in a communication terminal having a speech recognition function, the method comprising:
a step in which a speech recognition dictionary update support device uses a speech recognition dictionary of a communication terminal that is a source of dictionary data, to perform speech recognition on speech emitted from said communication terminal that is the source of the dictionary data, and also detects a word included in said speech recognition dictionary that is the source of the dictionary data, from a result of said speech recognition;
a step in which said speech recognition dictionary update support device transmits dictionary data corresponding to said detected word to a communication terminal that is a destination of dictionary data; and
a step in which said communication terminal that has received said dictionary data adds said dictionary data to its own speech recognition dictionary, according to a user operation.

16. A method of updating a speech recognition dictionary held in a communication terminal having a speech recognition function, the method comprising:
a step in which one communication terminal uses its own speech recognition dictionary to perform speech recognition on input speech, and also detects a word included in said own speech recognition dictionary from a result of said speech recognition;
a step in which said one communication terminal transmits dictionary data corresponding to said detected word to an other communication terminal; and
a step in which said other communication terminal adds said dictionary data to its own speech recognition dictionary, according to a user operation.

17. The speech recognition dictionary update support device according to claim 2, wherein
said speech recognition processing unit performs speech recognition on communication content between a communication terminal that is a destination and a communication terminal that is a source of dictionary data, and detects a word included in a speech recognition dictionary of said communication terminal that is the source of the dictionary data.

18. The speech recognition dictionary update support device according to claim 2, wherein
separately from said dictionary data, said speech recognition processing unit transmits a speech recognition result to said communication terminal that is the destination of the dictionary data.

19. The speech recognition dictionary update support device according to claim 3, wherein
text or phrase that is a usage example of a word is held in said speech recognition dictionary;
said speech recognition processing unit performs speech recognition by referring to said usage example; and
said dictionary data registration unit registers dictionary data including said usage example.

20. The speech recognition dictionary update support device according to claim 3, being built into a network side device that relays communication between a plurality of communication terminals, wherein
said speech recognition processing unit uses speech recognition processing unit uses speech recognition dictionaries received from said plurality of communication terminals to convert content of communication between said plurality of communication terminals into text, to be transmitted to each of said communication terminals, and also detects a word included in each of said speech recognition dictionaries, and
said dictionary data registration unit registers dictionary data corresponding to said detected word, in a speech recognition dictionary of a terminal that has ended said communication.
